(19) United States
(12) Patent Application Publication
(10) Pub. No.: US 2004/0147319 A1
(43) Pub. Date: Jul. 29, 2004

(54) Method of playing a game by a plurality of remote game participants

(76) Inventor: Rafael Aviyants, Manchester, NH (US)

Correspondence Address: Joseph E. Funk, PO Box 661, Londonderry, NH, 03053, US

(21) Appl. No.: 10/350,488

(22) Filed: Jan. 24, 2003

(51) Int. Cl. G06F 17/00

(52) U.S. Cl. 463/40

(57) ABSTRACT

A television game show game is disclosed that may be played by a large number of players who are spread out over a large geographical area and need not be present at the television studio, auditorium or other site where the game is played. The game comprises a plurality of rounds of game play in each of which the number of players who may continue to play in subsequent rounds of game play is reduced. Prizes are won in some of the rounds of game play while the first rounds of game play are used to reduce the number of players who may play in subsequent rounds of game play. The rounds of game play may be done in one session or may be spread out over a period of days or weeks.

### FIELD OF THE INVENTION

This invention relates generally to games of chance having a large number of participants, and more particularly to a game presented on television wherein the game players may be remote from the site at which the game is played.

### BACKGROUND OF THE INVENTION

Games of chance presented via the medium of television or via computer networks, including telephone networks, have grown over the years. Such games of chance may be played at web sites on the Internet by a plurality of players in different countries. Another type of such a game of chance is the lottery. Many players purchase one or more tickets from authorized ticket sales agents, and drawings for winners are periodically held using the broadcast medium of television. Such games are also somewhat progressive in nature in that if a ticket holder does not win a large jackpot they can win one of a plurality of smaller prizes. Lottery games of the latter type with a wider number of winners increase player interest and player participation beyond games having a single winner.

There are other types of games of chance that are played using the medium of television. These include the well known quiz shows and game shows. Many of these quiz shows have a progressive jackpot that grows larger after each successive question is answered correctly. However, each successive question is typically harder than previous questions. Participants can elect to take their winnings and cease playing at any point in the game. Such quiz shows typically draw large audiences. These quiz shows create interest because observers at television sets sometimes know answers to questions the game show participants do not know. In addition, in one popular television quiz show a player has a limited number of times that they can poll the studio audience regarding a correct answer.

The main problem with all these prior art progressive games is that only one or a very few players can actually participate in the games. Thus, there is a need for a progressive type game that can be played by a large number of players. In addition, there is also a need for a progressive type game where the players do not have to be present at a television studio or other central location in order to participate in playing a game.

### SUMMARY OF THE INVENTION

The needs in the prior art are met by the present invention. In general, the present invention comprises a telephonic-interface system and related processes for selectively utilizing both analog (voice) and digital telephonic communication (Internet) for game registration and participation. The game played may be of any of a wide variety of game formats as to accommodate a large number of game participants who most likely will be remote from the site where the game is actually played and presented via the media of television.

In a preferred embodiment of the invention a progressive type game having a first level of game play and a second level of game play each comprising a plurality of rounds of game play is taught. The game is broadcast via television and may be played by a large number of players who are not present at the television studio, auditorium or other site in order to play the game. This increases the interest level in the game and thereby creates larger viewing audiences. In addition, the players of the game may be spread over large geographic areas. Further, viewer interest is increased because enrolled players need no knowledge of any subject in order to have an equal chance at winning the larger prizes.

Persons who wish to play the game enroll for play via either a telephone or the Internet. During enrollment a person submits requested biographical data and receives a player enrollment number that is uniquely associated with the person.

The game consists of a plurality of rounds of play that are subsequently played at one time, such as during one evening, or may be played over an extended period of time. The initial three rounds of play of the game are based on the biographical data of enrolled players, submitted at the time of enrollment. These three rounds are used only to narrow the number of players remaining in play for subsequent rounds of the game and there are no prize winnings. There is no decision made by enrolled players regarding continuing to play following the first and second rounds of game play. If a player survives the initial three rounds of game play they are required to contact the game via the telephone or the Internet and, using their unique player enrollment number, either elect to continue to play subsequent rounds of the game or to drop out of the game. Players that elect to continue make a selection that is used during the fourth round of game play. The fourth round of game play is the first round during which a surviving player can win a prize.

At the end of the third round of game play, and at the end of each of the subsequent rounds of game play, a surviving player may elect to take their winnings, if any, and cease playing the game. Alternatively, they may elect to continue playing further rounds of the game and attempt to win more prizes. If a surviving player elects to continue playing the game they make a selection that is used for the following round of game play to win more prizes and to further narrow the number of players remaining in the game. Any of the rounds of game play may be played in continuous time sequence or may be played on subsequent days or weeks. In the final round of game play a surviving player that has elected to continue on to the final round gambles winning a larger prize, retaining their accumulated winnings, or losing all their winnings.

However, in alternative embodiments of the invention a single round of game play may be utilized.

### DESCRIPTION OF THE DRAWINGS

The game of the present invention will be better understood upon reading the following Detailed Description in conjunction with the drawings in which:

FIGS. 1A & 1B show a block diagram showing the steps in playing the game;

FIGS. 2A and 2B show selections and prize winnings for a fourth round of game play;

FIGS. 3A and 3B show selections and prize winnings for a fifth round of game play; and

FIGS. 4A and 4B show selections and prize winnings for a final round of game play; and

FIGS. 5A through 5C show how the first three rounds of game play are played.

### DETAILED DESCRIPTION

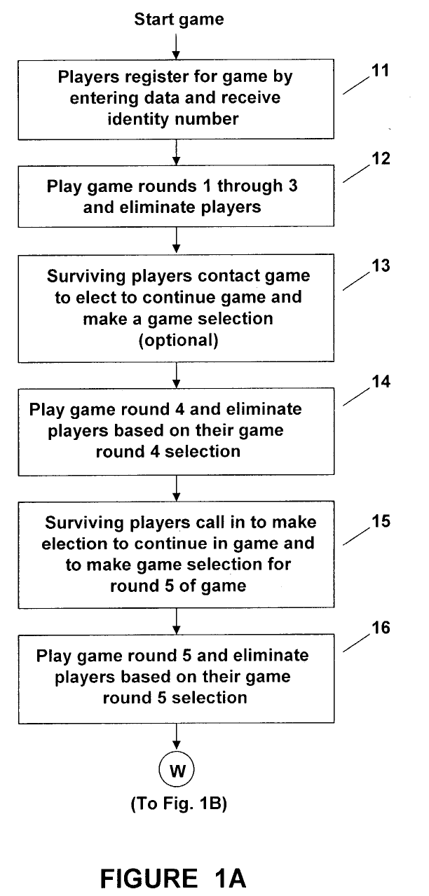

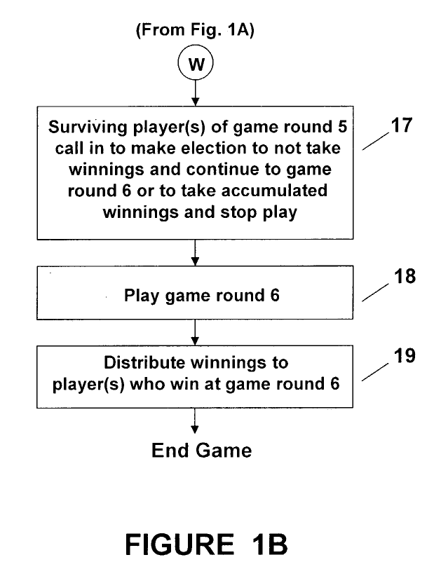

In FIGS. 1A & 1B is a block diagram showing the steps in playing the progressive game.

The game is broadcast via television and may be played by a large number of players spread over a large geographic area who need not be in attendance at a television studio, auditorium or other site in order to play the game. The game must be watched by enrolled participants in order to progress through one or more rounds of play of the game. Enrolled players need no knowledge of any subject in order to have an equal chance at winning any of the prizes, but the game may be played in a way as to require some skill of the players. These factors increase interest level in the game and create a larger viewing audience. A larger viewing audience is the goal of any television station or television network.

In the preferred embodiment of the invention the game consists of a first and a second level of game play each comprising a plurality of rounds of game play that may be played in one evening or over a period of time such as days or weeks. In the embodiment of the invention described herein there are six rounds of game play, but fewer or more rounds of game play may be utilized. In addition, the format of each round of game play may be changed without departing from the teaching of the present invention. Different game formats may increase the level of knowledge required by enrolled players. The game format should be varied after some period of time so interest game will remain high.

In FIG. 1A the game starts at block 11 with a player contacting the game show via either a telephone or via a website on the Internet, prior to the start of a game, to enroll in play of the game in which they can win cash or other prizes. A person may enroll and participate in every playing of the game and this will happen. When using the telephone to enroll in the game, a person is taken through a series of pre-recorded messages and responds to requests for information using the keypad of a touch tone telephone. When entering a birth date a depressed key on the telephone indicates the number being entered. When a player, for example, has a birth date of Oct. 17, 1972, and they asked during game enrollment for the month of their birth, they key in the number “10”. Two digits must always be keyed in. For the month of January a player will key in “01” and for the month of May a player will key in “05”. When the player of the example is asked for the day of their birth they key in “17”. Again two digits must always be keyed in. For the 5^{th} of a month a player will key in “05”. When requested to enter the year of their birth the player of the example will key in “72”. Two digits must always be keyed in.

If the Internet is used to enroll in a game, a person must go to the web site of the game show and select a button indicating they wish to enroll for the next game. They will be requested to type in their birth date and enter it by selecting a “Submit” button. If any other information is needed for playing in the game the enrolling player will be requested to enter it.

During the enrollment process a person submits their birth date and receives a player enrollment number that is uniquely associated with the person. Instructions are also given to enrolled persons on how to participate during each round of game play.

Some people may be hesitant to provide their birth date for a variety of reasons. In registering to play the game, via telephone of the Internet, a player will be informed that they may submit any other date they choose for play in the game and to record the chosen date.

In an alternative embodiment of the game a player doesn't receive an enrollment number when they call in to register to play the game. Rather, the caller identification feature of the telephone system captures the phone number from which the enrolling player calls from and the phone number is the player identification. Thereafter, each time the player must call in to provide elections to continue to play and selections within rounds of a game, they must call from the same telephone because that phone number is captured to identify who they are.

When a calling number is not captured by the caller identification during registration the player is asked to enter their phone number. When a player subsequently calls the game show to make game elections and selections their phone number is either captured and thereby identifies them, or when the number is not captured they are asked to enter the phone number.

Similarly, when a player registers to play the game via the Internet part of the registration process is entering their phone number. During the course of the game when a player contacts the game show via the Internet to make game elections and selections they again enter their phone number to identify them. With this arrangement a player may use both the communication modes of the telephone and the Internet during a game to register and to make game elections and selections.

At block 12 the game format of the first level of game play comprises three rounds of the game that are based on birth date information submitted by enrolled players. Each of these three rounds of game play is used to decrease the number of players surviving to play subsequent rounds of game play.

Any other information, other than a birth or other date may alternatively be used to play the early rounds of the game. For example, an area code, an office code and a line number may be picked during the first three rounds of game play.

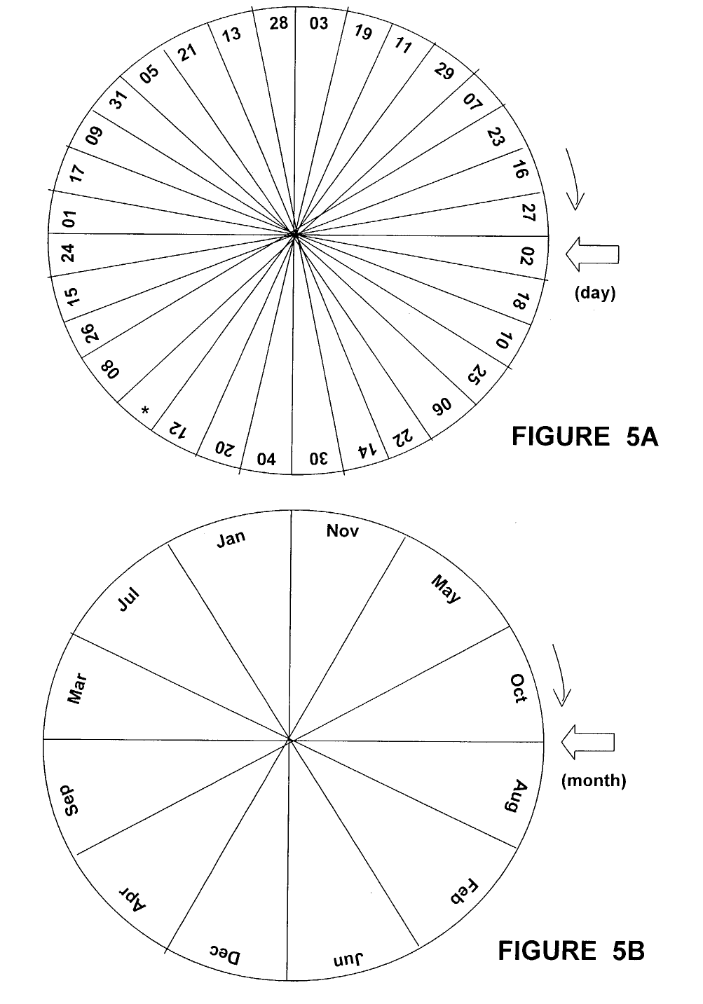

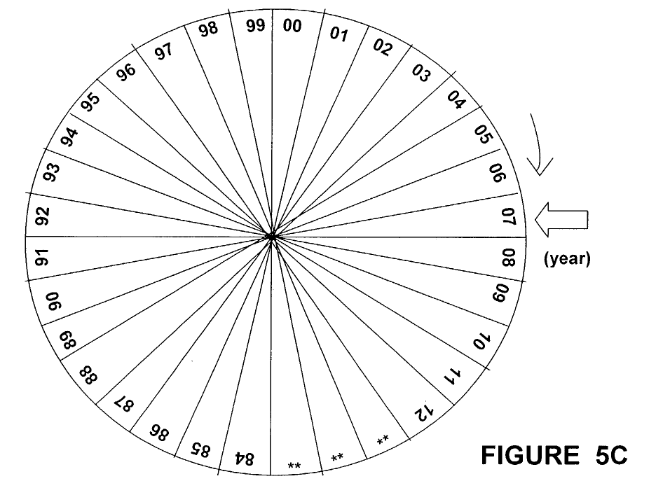

In the first round of game play a month is randomly selected. Only those enrolled players whose birth month matches the selected month survive to the second round of game play. Selection of a month can be done in a variety of well known ways, only one of which is shown in and described with reference to FIG. 5A. For example, if a person's birth date is Nov. 24, 1967 and the randomly selected month is November, they will survive to play the second round of game play. Statistically a large number of people will survive the first round of game play, while a large number of people will not survive. The number of surviving players is being narrowed down, but the narrowing is the least by having the month first. This will keep the maximum number of people and players interested in the game. There are no winnings associated with surviving game round one.

In the second round of game play a numerical day of the month is randomly selected. Only those surviving players whose numerical day of the month matches the selected numerical day of the month survive to the third round of game play. Selection of a day of the month can be done in a variety of well known ways, only one of which is shown in and described with reference to FIG. 5B. Using the prior example, if the randomly selected day of the month is 24, the person, a Mr. Gomez, with the Nov. 24, 1967 birth date survives to play the third round of game play. Statistically a fairly large number of people will survive the second round of game play, while a large number of people will not survive. There are no winnings associated with surviving game round two.

In the third round of game play a year is randomly selected. Only those surviving players whose birth year matches the selected birth year survive to the fourth round of game play. Selection of a year can be done in a variety of well known ways, only one of which is shown in and described with reference to FIG. 5C. Using the prior example, if the randomly selected year is 1967, the person with the Nov. 24, 1967 birth date survives to play the fourth round of game play. Statistically a not too large group of people will survive the third round of game play, while a much larger number of people will not survive. There are no winnings associated with surviving game rounds one through three.

At block 13 the surviving players of the third round of game play, all of whose birth date matches the Nov. 24, 1967 date randomly selected in game rounds one through three, must contact the game show via telephone or the Internet. Using their unique enrollment number to identify themselves they may elect to drop out of game play and not progress to game round four of the second level of game play, or they may elect to continue into game round four. With the surviving players having no winnings thus far and an excellent chance to win something, it is anticipated that all surviving players of game round three will continue to game round four. If a surviving player fails to contact the game show following winning in game round three, and in the allotted time before the start of game round four, they are dropped from play in the game. This mode of play will help assure that people watch the game show.

In an alternative embodiment of the invention players do not elect to drop out of play for game round four, but they still contact the game show to make their selection for play in game round four as described in the following paragraph. Alternatively, all game selections for all rounds of game play may be picked during registration.

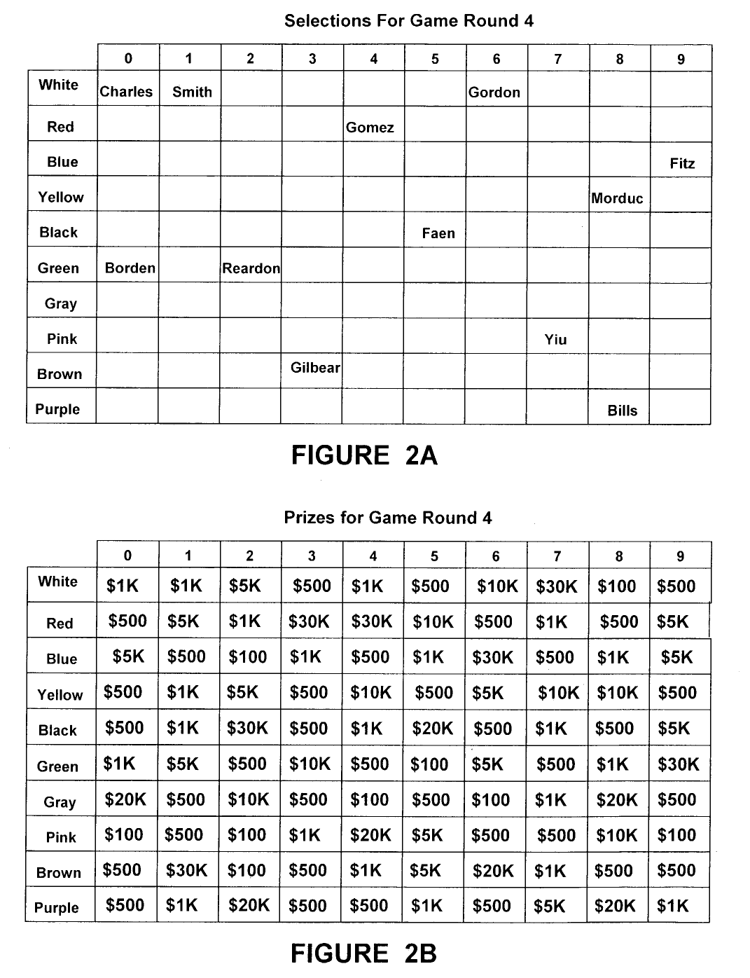

After making an election to continue game play into game round four, the surviving players make a selection that will be used for their participation in game round four. In the game format described herein the surviving players select a block designated by a color and a number from the chart shown in and described with reference to FIG. 2A. After they make the selection and forward it to the game show via the telephone and its push buttons or the Internet using a computer or other device, their name appears in their chosen block on the table as shown in FIG. 2A. This process is automatic and does not require any human intervention at the game show. If the exemplary surviving person, Mr. Gomez, elects to continue in the game and selects “White 4” his name appears in that block as shown in FIG. 2A. Other surviving persons who elect to continue in the game also make their selections and their names appear in their chosen block on the table as shown in FIG. 2A. FIG. 2A is described further in this specification. This game format does not require any skill on the part of the players. Other game formats, that may or may not require some level of skill, may be used in place of the game format described in this paragraph.

In FIG. 2A only twelve players are shown who have the chosen birth date of Nov. 24, 1967. This is done only for the sake of simplicity to avoid cluttering up the drawing figure. Actually, there might be a hundred or more enrolled players whose birth date is Nov. 24, 1967.

At block 14 game round four is played. All of the players listed on the chart shown in FIG. 2A win a dollar prize associated with the block they have each chosen. The dollar amount indicated under each person's name indicates the value of the monetary prize they have won. This is shown in and described with reference to FIG. 2B. In the present example, Mr. Gomez has won a prize of $50,000. Other surviving players have won prizes of smaller amounts as seen in FIGS. 2A and 2B. In lieu of money prizes actual products such as a televisions set may be prizes in game round four. All players that win prizes of $5,000 or lower are eliminated from the game. This further narrows the number of players to about one-third the number of players that played in game round four. The $5,000 figure is arbitrary and is used to limit the number of players that continue on to the next game round. The number may be changed during game play depending on how many players survive a round of game play.

At block 15 the surviving players of the fourth round of game play must contact the game show via telephone or the Internet. Using their unique enrollment number to identify themselves they may elect to drop out of game play and not progress to game round five, or they may elect to continue into game round five. If a surviving player fails to contact the game show following winning in game round four, and in the allotted time before the start of game round five, they are dropped from play in the game. This mode of play will help assure that people watch the game show.

In an alternative embodiment of the invention players do not elect to drop out of play for game round five, but they still contact the game show to make their selection for play in game round five as described in the following paragraph. However, there may be an election to continue in game round five although there is no election to continue in game round four.

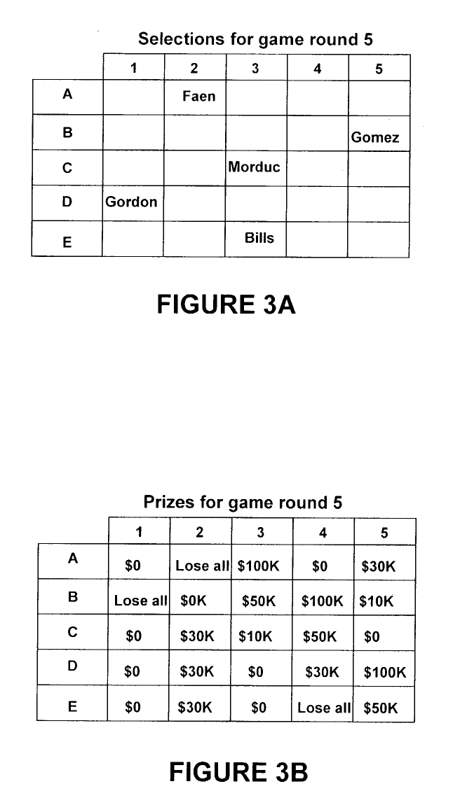

After making an election to continue game play into game round five, the surviving players make an alpha-numeric selection that will be used for their participation in game round five. In the preferred game format of the invention the surviving players select a block designated by a letter and a number from the chart shown in and described with reference to FIG. 3A. After they make the selection and forward it to the game show via the telephone and its push buttons or the Internet using a computer or other device, as previously described, their name appears in their chosen block on the table as shown in FIG. 3A. This process is automatic and does not require any human intervention at the game show.

Before making their decision whether or not to continue in the game into game round five, a surviving player (one having winnings in game round four in excess of $5,000) is warned that, unlike game round four, there is a chance that they may lose all their winnings from game round four, there is a chance they will get no additional prize money, or they can win additional prize money.

If the exemplary person Mr. Gomez, who won $50,000 in game round four, elects to continue in the game and selects “B 5” to participate in game round five, his name appears in that block as shown in FIG. 3A. Other surviving persons who elect to continue in the game also make a similar selection and their names appear in their chosen blocks on the table as shown in FIG. 3A. FIG. 3A is described further in this specification. This game format does not require any skill on the part of the players. Other game formats, that may or may not require some level of skill of the players, may be used in place of the game format described in this paragraph and for other rounds of the game.

An example of an alternate game format requiring ni player skill is to have each player select a sequence of one or two digit numbers, like a televised lottery. During play of a game in which this game format is used, and just like a televised lottery, a tumbling wire cage with balls therein having numbers thereon is used to select numbers to select the winner(s) of a game round.

At block 16 game round five is played. All of the players listed on the chart shown in FIG. 3A will: (a) win a dollar prize associated with the block they have each chosen, (b) win no additional prize money as associated with the block they have each chosen, or (c) lose all prize money from game round four and be out of the game. The result of each surviving players alpha-numeric choice is shown in and described with reference to FIG. 3B.

As shown in FIGS. 3A and 3B Mr. Gomez has won an additional prize of $10,000, giving him total winnings thus far of $60,000. Mr. Morduc has won an additional $10,000, giving him total winnings thus far of $20,000. Both Messrs. Morduc and Gomez may elect to continue to game round 6. Other surviving players have won additional prizes, or no prizes, or have lost all their winnings as seen in FIGS. 3A and 3B. As may be seen when comparing FIGS. 3A and 3B, Messrs. Yiu and Gordon win no additional prize money but they can take their winnings and they are out of the game.

At block 17 the surviving players of the fifth round of game play must contact the game show via telephone or the Internet. Using their unique enrollment number to identify themselves they may elect to drop out of game play and not progress to game round six, or they may elect to continue into game round six. If a surviving player fails to contact the game show following surviving game round five, and in the allotted time before the start of game round six, they are dropped from play in the game. This mode of play will help assure that people watch the game show.

Before making their decision whether or not to continue in the game into game round six, a surviving player is warned that, unlike game round five, there is a chance that they may either lose all their winnings from previous game rounds, or they can win additional prize money.

At block 18 game round six is played with surviving players, if any, who elect to continue on and play game round six. Assume that a player elects to play game round 6. The odds of winning at game round 6 are lower than previous game rounds, but the prize winnings are greater. The surviving player is informed of the number of blocks having each amount of additional prize money, and the number of blocks under which they can lose everything.

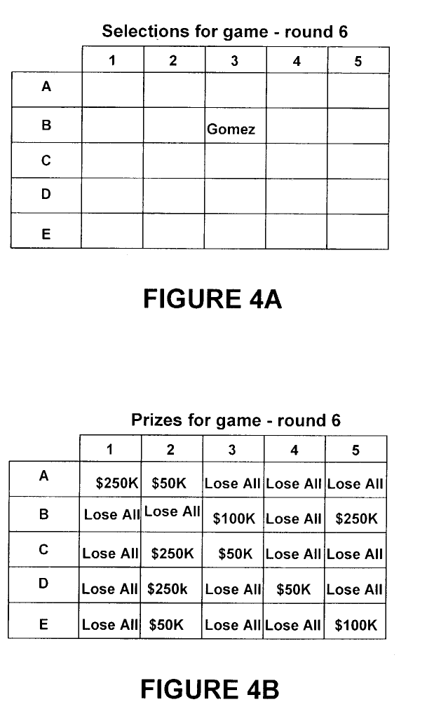

The one player has to make an alpha-numeric selection to be used in play of game round 6. That selection is in the range of A1-A5 through E1-E5 as seen in FIG. 4. Assume that the one player selects block B-3. Block B-3 is then exposed showing that the one player has won an additional $100,000. The one player takes a gamble of losing all because there is a good chance that they could select a box indicating that they lose all accumulated prize winnings.

At block 19 prize winnings are distributed to players who have retained their prize winnings and the game is over.

In FIG. 2A is shown the player selection matrix for the fourth round of each game. Players whose birth date is selected in the first through third game rounds must contact the game show to first indicate that they wish to continue to play into the fourth round of the game. With these players having no winnings thus far and an excellent chance to win something, it is anticipated that all surviving players of game round three, whose birth day has been selected, will continue to game round four. If they elect to continue to play they must contact the game show using a touch tone telephone or via the Internet using a computer or other device and indicate their wish to continue into game round four, as previously described. At the same time they must select a block in the matrix shown in FIG. 2A that indicates a color and a number that is used in the play of the fourth game round. After a player's selection is forward to the game show their name appears in their chosen block in the matrix as shown in FIG. 2A. This process is automatic and does not require any human intervention at the game show.

In FIG. 2A are listed a number of exemplary surviving persons whose birth day has been selected and who have selected the blocks in which their last name appears for game round 4. Mr. Gomez has selected “White 4” his name appears in that block as shown in FIG. 2A. The other surviving persons in the game also make their selections and their names appear in their chosen block on the table as shown in FIG. 2A. As shown Mr. Charles has selected White 0, Mt. Smith has selected White 1, Mr. Gordon has selected White 6, Mr. Gomez has selected Red 4, Ms. Fitz has selected Blue 9, Mr. Morduc has selected Yellow 8, Mr. Faen has selected Black 5, Mr. Borden has selected Green 0, Mrs. Reardon has selected Green 2, Mr. Yiu has selected Pink 7, Mrs. Gilbear has selected Brown 3, and Mr. Bills has selected Purple 8.

Associated with each block in the matrix shown in FIG. 2A is a money prize as shown in the corresponding matrix in FIG. 2B. The amounts are selected in a random manner prior to the start of the game. Only after game round four is played do the players get to know the amount of money they have won in game round four. On the television game show the players are shown their prize one at a time for heightened game suspense. Messrs. Reardon, Gilbear and Yiu have each won $500. Messrs. Charles, Smith and Borden have each won $1,000. Mr. Fitz has won $5,000. Messrs. Morduc and Gordon have each won $10,000. Messrs. Faen and Bills have each won $20,000. Mr. Gomez has won $30,000. The biggest prize that could be won in game round four is $50,000. Of these prize winners only those who have won more than $5,000 survive to continue on to game round five if they so choose. That includes only Messrs. Morduc, Gordon, Faen, Bills and Gomez. Thus, from an initial group of players that number in the thousands only five players survive to play game round five.

At the end of game round four the surviving players Messrs. Morduc, Gordon, Faen, Bills and Gomez must each contact the game show, as previously described, to either indicate their election to continue in the game to game round five, or to take their prize from game round four and drop out of the game. In the scenario described herein all five survivors elect to continue into game round five. Those who elect to continue into game round five must select a block in the matrix shown in FIG. 3A. After a player's block selection is forward to the game show their name appears in their chosen block in the matrix as shown in FIG. 3A. This process is automatic and does not require any human intervention at the game show.

Associated with each block in the matrix shown in FIG. 3A is one of three results. An additional money prize, no additional prize but the player retains their existing winnings, and the player loses their existing prize from game round four. These results are shown in the corresponding blocks of the matrix shown in FIG. 3B. The results and dollar amounts are selected in a random manner prior to the start of the game. Only after game round five is played do the players get to know the results. On the television game show the players are shown the result of their block selection one at a time for heightened suspense. In the example being described, Mr. Faen loses the $20,000 he won in game round four and exits the game with no prizes. Mr. Gomez wins an additional $10,000, making his prizes a total of $40,000. Mr. Morduc wins an additional $10,000 making his prizes a total of $20,000. Mr. Gordon wins no additional prize but exits the game with his prize of $10,000 from game round four. Mr. Bills wins no additional prize but exits the game with his prize of $10,000 from game round four. The biggest prize that could be won in game round five is $100,000. Thus, only Messrs. Gomez and Morduc survive to decide if they want to on to game round six.

After game round five the surviving players Messrs. Gomez and Morduc must each contact the game show, as previously described, to either indicate their election to continue in the game to game round six, or to take their accumulated prizes after game round five and drop out of the game. In the scenario described herein Mr. Gomez elects to continue into game round six, and Mr. Morduc elects to take his prizes and exit from the game. The odds of winning at game round six are lower than previous game rounds, but the prize winnings are greater. The surviving player is informed of the number of blocks having each amount of additional prize money, and the number of blocks under which they can lose everything. Those who elect to continue into game round six must select a block in the matrix shown in FIG. 4, and Mr. Gomez selects block B3. After a player's block selection is forward to the game show their name appears in their chosen block in the matrix as shown in FIG. 4A. This process is automatic and does not require any human intervention at the game show. The player, Mr. Gomez, takes a gamble of losing all because there is a good chance that they could select a box indicating that they lose all accumulated prize winnings.

As game round play six is played Mr. Gomez is found to have won an additional $100,000, as shown in FIG. 4B, making a total of $140,000. The largest prize that could have been won in game round six is $250,000. The game is over.

In an alternative embodiment of the game players do not risk losing all accumulated prizes in the sixth round of the game based on the selection of a block in the matrix of FIG. 4A. Rather, they may select a portion of their accumulated winnings to play in the final round of the game to either win an additional larger prize or to lose the selected portion. The size of the prizes in this alternative final round of game play should be large enough to make the risk of losing the player selected portion of prize winnings an acceptable risk, and the size of the potential prize winnings in the alternative final round of game play will vary depending on the size of the player selected prize portion played in the final round of game play.

In FIG. 5A is shown a game wheel of the spinning type, such as used on popular television game shows such as “Wheel of Fortune”. In the embodiment described herein such a game wheel is used for the first three rounds of game play to select a birth date. The wheel of FIG. 5A is spun by someone on the game show on television and when the wheel stops a fixed indicator points to the numerical day of a month of a birth date that is being randomly selected.

In FIG. 5B is shown another game wheel that is spun by someone on the game show on television and when the wheel stops a fixed indicator points to a month of the birth date being randomly selected.

In FIG. 5C is shown another game wheel that is spun by someone on the game show on television and when the wheel stops a fixed indicator points to a year for the birth date being randomly selected.

As previously described, the birth date randomly selected by the spinning wheels in FIGS. 5A-5C is used to thin the number of players in the game and only those players having the randomly selected birth date may continue to play further game rounds.

In an alternative embodiment of the invention actual spinning game wheels may be replaced by other means such as, but not limited to, an electronic version thereof displayed on a video monitor. In addition, other random selection means maybe use such as wire drums with balls having dates, years or the names of months thereon. After some rotation of the drums to thoroughly mix the balls a ball is allowed to exit the drum to read the information printed on it. Such drums are widely used in lotteries that are broadcast via television.

While what has been described above is the preferred embodiment of the novel game, it will be appreciated by those skilled in the art that many changes may be made without departing from the scope of the invention.

For example, instead of using player's birth dates to narrow down the number of players in early game rounds, the early game round selections could be player's first, middle and last name initials, followed by the identity of a town/city, and street, and even a state. The possible game format possibilities are extensive for the early rounds of game play.

To create a more interactive lottery game type format, during registration enrolling players could be required to pay a fee that is placed in a winnings pot. The money in the pot can be used to pay the winner(s) of the game and some registration fees can be used for schools or other notable purposes.

For a further example, fewer or more rounds of game play may be involved in a play of the game. Further, other than money prizes may be won. The game format at different rounds of game play may be different. The box selection format, which requires no player skill, may be replaced at any round of game play with a game format that requires some level of player skill. For example, a player may be required to call the game show and answer a question.

Still further, the sixth and final game round need not be played at the end of each play of the game. The surviving players of game round five from a number of games, and who elect to continue to game round six, may be brought together and a “super” game round six played with them all.

In yet another alternative embodiment of the invention, game players remote to a television studio or auditorium where the game will be played will remotely register to play the game. The game may consist of any type of game, with or without multiple rounds of game play

What is claimed is:

1. A method of playing a game that has a number of rounds of game play, the method comprising the steps of:
registering a plurality of players to play the game;
playing a first level of game play comprising first plurality of rounds of the game, the first plurality of game rounds providing an incentive for the plurality of players to continue to play the game, each of the first plurality of game rounds narrowing the number of players remaining in the game;
playing a second level of game play comprising a second plurality of rounds of the game, each of the second plurality of game rounds narrowing the number of players remaining in the game, each of the second plurality of game rounds having risk regarding winning prizes; and
determining whether each player remaining in the game after each of the second plurality of rounds of the game has elected to play the next round of the second plurality of game rounds or to exit the game with their accumulated prizes.

2. The method in accordance with claim 1 wherein the players need not be in a studio or other location where the game is being played, but may be scattered geographically.

3. The method in accordance with claim 2 wherein the players register to play the game and indicate their election to continue to play in the game after each of the second plurality of rounds of the game using a communication channel.

4. The method in accordance with claim 3 wherein when each player registers to play the game they each receive a unique identifier code to identify them when they indicate their election to continue to play in the game after each of the second plurality of rounds.

5. The method in accordance with claim 4 further comprising the step of receiving game selections from each player remaining in the game following each round of the second level of game play, the selection being used for playing in the next round of the game.

6. The method in accordance with claim 5 wherein there are no prize winnings in the first level of game play.

7. The method in accordance with claim 1 wherein when each player registers to play the game they each receive a unique identifier code to identify them when they indicate their election to continue to play in the game after each of the second plurality of rounds.

8. The method in accordance with claim 7 wherein the players need not be in a studio or other location where the game is being played, but may be scattered geographically.

9. The method in accordance with claim 8 wherein the players register to play the game and indicate their election to continue to play in the game after each of the second plurality of rounds of the game using a communication channel.

10. The method in accordance with claim 9 further comprising the step of receiving game selections from each player remaining in the game following each round of the second level of game play, the selection being used for playing in the next round of the game.

11. The method in accordance with claim 1 further comprising the step of receiving game selections from each player remaining in the game following each round of the second level of the game, the selection being used for playing in the next round of the game.

12. The method in accordance with claim 11 wherein when each player registers to play the game they each receive a unique identifier code to identify them when they indicate their election to continue to play in the game after each of the second plurality of rounds.

13. The method in accordance with claim 12 wherein there are no prize winnings in the first level of game play.

14. A method of playing a game that has a number of rounds of game play, the method comprising the steps of:
registering a plurality of players to play the game;
playing a plurality of rounds of the game, each of the plurality of game rounds narrowing the number of players remaining in the game; and
determining whether each player remaining in the game at the end of certain rounds of the game has elected to play further rounds of the game or to exit the game;
wherein the players need not be in a studio or other location where the game is being played and they registration and communicate their elections using a communication channel.

15. The method in accordance with claim 14 further comprising the step of receiving game selections from each player remaining in the game via the communication channel following each round of the game, the selection being used for playing in the next round of the game.

16. The method in accordance with claim 15 wherein when each player registers to play the game they each receive a unique identifier code to identify them when they indicate their elections to continue to play in the game and when they submit their game selections used for playing in the game.

17. The method in accordance with claim 14 wherein the game is played on television.

18. The method in accordance with claim 14 wherein when a player registers to play the game they submit their birth date, and in certain rounds of the game a month, a day and a year are selected, and players whose birth date is selected continue on to further game rounds.

19. The method in accordance with claim 1 wherein when a player registers to play the game they submit their birth date, and in the first plurality of game rounds a month, a day and a year are selected, and players whose birth date is selected continue on to the second plurality of game rounds.

20. The method in accordance with claim 1 wherein when a player registers to play the game their phone number is either captured using caller identification or is submitted by the player, and each time thereafter that a player contacts the game they are identified by their phone number.

21. A method of playing a game presented on television comprising the steps of:
registering a plurality of players to play the game using a communication channel, wherein the players need not be in a studio or other location where the game is being played;
receiving game elections from players using a communication channel;
televising the game as it is being played; and
determining which player or players win the game.
